(19) United States
(12) Patent Application Publication
(10) Pub. No.: US 2011/0288945 A1
(43) Pub. Date: Nov. 24, 2011

(54) ELECTRONIC PRICE SYSTEM AND A METHOD AND A COMPUTER PROGRAM FOR THE ELECTRONIC PRICE SYSTEM

(75) Inventors: Hannu Karhuketo, Tuusula (FI); Jukka Enarvi, Tampere (FI)

(73) Assignee: MARISENSE OY, Vantaa (FI)

(21) Appl. No.: 13/124,482

(22) PCT Filed: Oct. 16, 2008
(86) PCT No.: PCT/FI2008/050578

§ 371 Date: Aug. 11, 2011

(51) Int. Cl. G06Q 20/00

(52) U.S. Cl. 705/20

(57) ABSTRACT

An electronic price system comprising at least a cash register (27) and at least one electronic label (1, 2) for displaying a first price of a product is disclosed. The electronic price system is configured to transmit a second price to the electronic label (1, 2), said second price replacing the first price in said electronic label (1, 2) and to transmit the second price to the cash register (27) to be displayed with the first price for a predetermined time period at the cash register (27). The system is further configured to provide during said predetermined time period a possibility at the cash register (27) to accept the second price or the first price. Also a method for the electronic price system and a computer program are disclosed.

### FIELD OF THE INVENTION

This invention relates to an electronic price system. In addition this invention relates to a method and a computer program for the electronic price system. The electronic price system comprises at least a cash register and at least one electronic label for displaying a first price of a product, wherein said electronic price system is configured to transmit a second price to the electronic label, said second price replacing the first price in said electronic label.

### BACKGROUND OF THE INVENTION

An electronic price display system is a modern way of showing price information to a consumer in a store. Stores not having electronic price display system comprise many discrepancies between prices shown to the customer in shelf edges and prices in POS (Point of Sale) system or at cash terminals. This causes mistrust amongst consumers to store's capability to sell products at promised prices. Use of electronic price display system adds great amount of accuracy in this respect.

One example of an electronic price display system is presented in applicant's international publication WO 2006/087424. In this publication thin, flexible, laminated price labels are disclosed, which electronically display price information that can be updated centrally and remotely, e.g. from a central computer or similar device. The price labels resemble traditional paper labels placed at edges of shelves. In applicant's international publication WO 2008/025879 another kind of an electronic label has been presented. The electronic label presented in the latter publication differs from the first publication by its purpose. This kind of electronic label is aimed to be used for displaying prices of e.g. in fruits and vegetables, and it is larger than the shelf edge label being described above.

Regardless of the purpose, such electronic labels consist an electronic display, e.g. electronic ink based display, an LCD display or other, into which price information is transmitted. This kind of transmittal of price makes it easier to change prices and use e.g. promotions and sales more frequently. In addition, the price provided to the cash register corresponds to the price displayed by the electronic label because the information is transmitted substantially at the same time. However, because the prices can be easily changed, there will be a problem when a customer picks a product from a shelf and the price of the product changes during the time needed by the customer to walk to the cashier. In such a situation the cashier most likely charges a different price than what the customer has seen. Obviously this is a greater problem when the price has been risen. Lower price usually is considered as a pleasant surprise. However, in both cases the customer is charged a different price that s/he was expecting to pay for the product.

U.S. Pat. No. 5,988,498 describes one solution for the problem. In this solution the availability of the price change is delayed by a predetermined time to checkout terminals following the price change. By this, the customer is expected to have enough time to proceed to the cashier after the price change. However, this solution is not perfect in the sense that the time needed for the customer to reach the cashier may vary widely and the system cannot check this case by case. Therefore, the customer may be still charged with the incorrect price other than the one that was displayed to the customer when he/she picked the product from the shelf.

It is still realized that a new solution for the problem is needed.

### SUMMARY OF THE INVENTION

The present invention is targeted to a solution for the above mentioned problem. It is an aim of the present invention to provide a solution that allows changing prices during shopping hours, but still is capable of charging such a price from a customer that gives customer a positive image of the store even if the price has just been risen when the customer arrives to a cashier. The application is therefore targeted to a method for an electronic price system, to the electronic price system and to a computer program for the electronic price system.

An example of the method for an electronic price system comprising at least a cash register and at least one electronic label for displaying a first price of a product, wherein a second price is transmitted to the electronic label, said second price replacing the first price displayed in said electronic label, comprises transmitting the second price to the cash register to be displayed with the first price for a predetermined time period at the cash register, and providing during said predetermined time period a possibility at the cash register to accept the second price or the first price.

An example of the electronic system that comprises at least a cash register and at least one electronic label for displaying a first price of a product, wherein said electronic price system is configured to transmit a second price to the electronic label, said second price replacing the first price in said electronic label, is configured to transmit the second price to the cash register to be displayed with the first price for a predetermined time period at the cash register, and to provide during said predetermined time period a possibility at the cash register to accept the second price or the first price.

An example of the computer program for an electronic price system comprising at least a cash register and at least one electronic label for displaying a first price of a product, comprises program code means configured, when the program is run on a computer, to transmit a second price to the electronic label, said second price replacing the first price in said electronic label, and to transmit the second price to the cash register to be displayed with the first price for a predetermined time period at the cash register, and to provide during said predetermined time period a possibility at the cash register to accept the second price or the first price.

By means of the invention the consumer pays the price s/he has seen on the price label or a lower price. In either case, the customer is given a positive shopping experience due to the knowledge of an influence of the cashier to the prices being charged.

### DESCRIPTION OF THE DRAWINGS

In the following the invention will be described in greater detail with reference to embodiments illustrated in the attached drawings, in which

FIGS. 1a, b illustrate examples of electronic price labels in a simplified manner,

FIG. 2 illustrates an example of an electronic price system as a reduced block chart,

FIG. 3 illustrates method steps for the solution according to one example, and

FIGS. 4a, b illustrate examples of display views in the cash register.

### DETAILED DESCRIPTION OF THE INVENTION

The present invention relates to electronic labels that can be used in stores for displaying price information. The labels can be shelf edge labels or labels placed in hanging protective pockets or arranged in any other way in the shop. The labels may be based on any display technology and use wireless or wired connections to the shop systems.

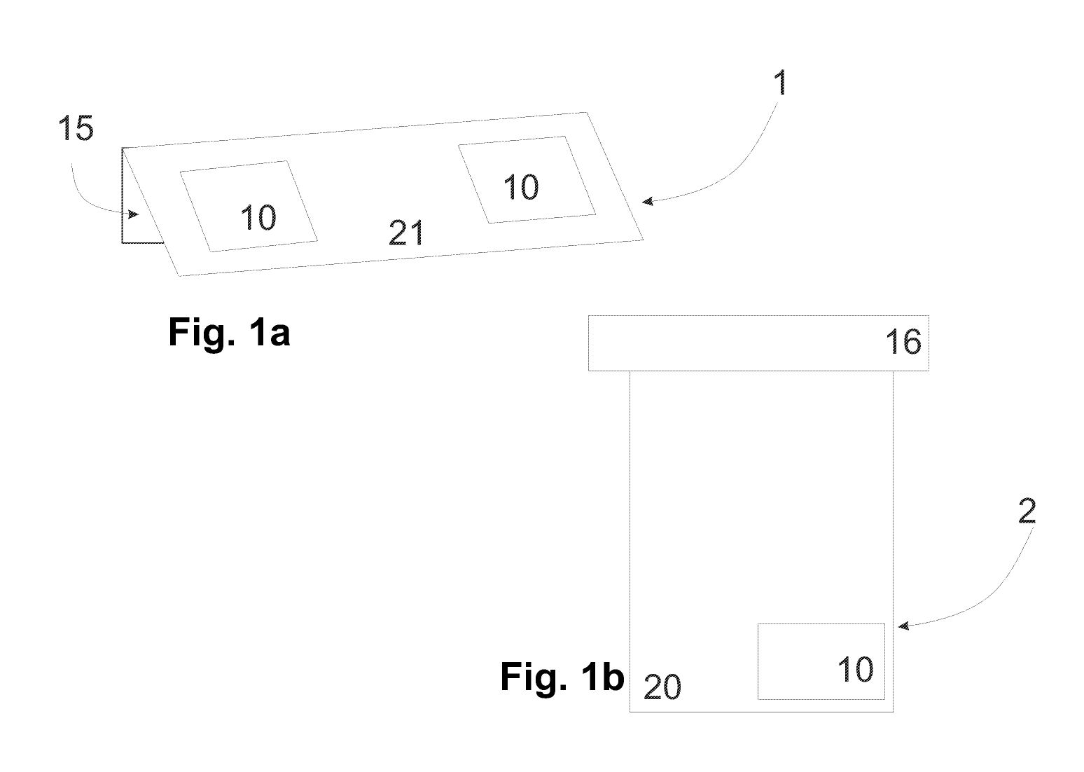

FIGS. 1a and 1b illustrate examples of different types of electronic labels. FIG. 1a illustrates an electronic shelf edge label 1 comprising a transparent “pocket” 21 within which an electronic display 10 is placed. The protective pocket is fixed to a support 15. Similarly, an electronic label 2 of FIG. 1b comprises an electronic display 10 being placed into a protective pocket 20 that is hanging from a support 16. The electronic labels 1, 2 comprise also display drivers, control conductors and other electronics needed to control the electronic display. The price information is transmitted from a central computer wirelessly or in a wired manner.

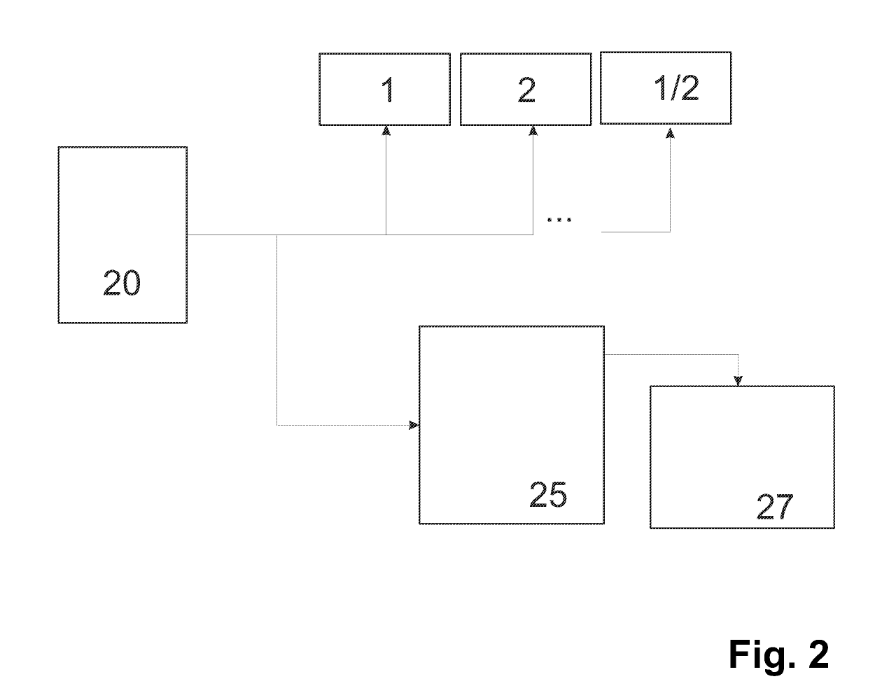

FIG. 2 illustrates as an example in a very simplified manner a structure for the present system. The electronic price system comprises a cash register 27, a POS system 25, a central computer 20 and varying amount of electronic labels 1, 2. The central computer 20 is configured to transmit a price information to the electronic labels 1, 2 and to the POS 25. The central computer may be programmed to operate according to a predefined pricing plan automatically (e.g. for happy hours that will be described later) or as result of user input. When a price is changed from the central computer 25 for a certain product, both the electronic label 1, 2 of the product and the POS system 25 get the new price. The electronic label 1, 2 will show the price to the consumers. The cash register 27 will get the same information via POS system 25. During a specified time, the cash register 27 will show a specific sign telling cashier that this price was just changed. The specified time can be anything predetermined, but typically selected from between 20-120 minutes. When a customer arrives the cash register 27 with a product whose price has been increased, the cashier may tell to the customer of the changed price, and accept the old (i.e. the cheaper) price which will stay available as a selection in the cash register 27. If a price has been decreased, the cashier may again tell about it and use the decreased price in favour of the customer. It is realized that this adds positive interaction between store personnel and customers. It also adds reliability, accuracy and sense of fairness to the image of the store and the whole chain of stores as usually is the case. This chain of actions can be automated and used in automatic cash register systems, too.

To make the electronic pricing system even more accurate, price change at cash registers 27 may happen only after the electronic price label 1, 2 has answered the central computer 20 and confirmed that the price change has taken place in reality. By this, the cashier can be sure that the labels comprise the changed price.

The present invention also makes it possible to have “happy hours” during e.g. silent shopping hours. This means that the store gives an additional discount to a consumer during this period of price change. Obviously the additional discount can be selected freely, but typically 2-10% of the actual price. This will further be great plug to the store, and can clearly point out to consumer how well under control and on time the pricing is being taken care in the store or chain. And, naturally, when placed to certain hours of the day, the prices may attract customers to the store even during silent hours.

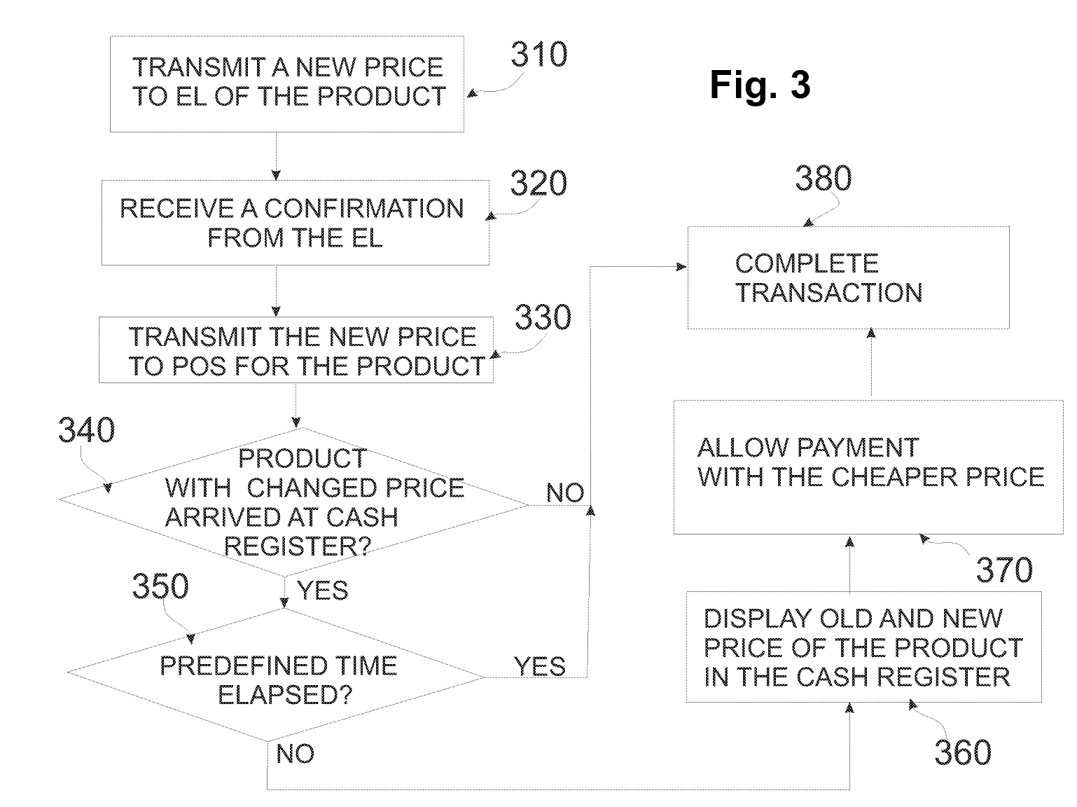

FIG. 3 illustrates an example of the method as a simplified flow chart. In the method a new price is transmitted (310) to an electronic label (EL) of a certain product from a central computer. As an optional step (320), the central computer may expect a confirmation from the electronic label before it transmits (330) the changed price information to the POS system. When a product is being bought at the cash register, it is automatically noticed whether the price of the product has been changed recently (340). If this is not the case, the transaction is completed (380) normally. If the product has a new price, it is determined if the predefined delay has elapsed (350). If so, the transaction is completed (380) normally with the changed price. If not, both the old price and the new price is displayed (360) simultaneously to the cashier in the cash register. The cashier may select the cheaper price for product regardless whether it is the old or the new price, and the payment with the cheaper price is accepted for the product (370) after which the transaction is completed (380).

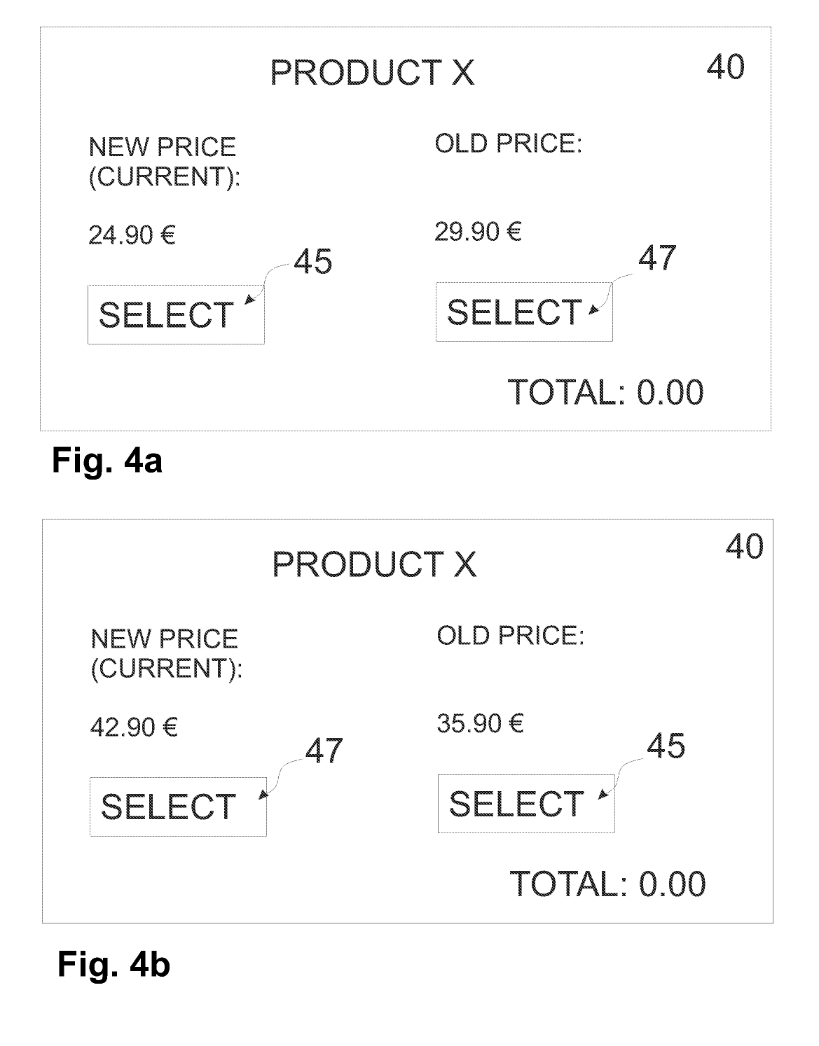

FIG. 4 illustrates in a simplified manner a cash register display for a product X having a recent price change.

Display 40 in FIG. 4a presents product's new price (i.e. current price) that is 24.90 [symbol] together with the price a moment ago (i.e. old price) that was 29.90 [symbol] . The display 40 (e.g. a touch panel) gives a possibility to select either price by selection buttons 45, 47. In the example presented by FIG. 4a, the cash register needs to notice from the prices, which one is the cheaper one, but it is appreciated that the selection button of the cheaper one can be highlighted e.g. by a different colour (e.g. green for a cheaper price, red for the more expensive), by a blinking feature or by any illustrative way.

Similarly in FIG. 4b, the product X has a new price, which—in this example—is more expensive than the price before. Also in this, the prices are shown simultaneously. In the FIG. 4b, there is a selection 45 for the cheaper price and a selection 47 for the more expensive price. The cashier may select either one of these prices, but preferably the cheaper one. It is appreciated that after the specified time after the price change has been elapsed, the display 40 shows only one price in both examples.

The cash register display may also show the time elapsed, for example in minutes, when the price change took place at the price display. This gives more possibility for the cashier to adopt to the given situation and decide which price is fair to be used in that particular case. In addition to the manual selection of prices, it is also possible—in some situations—to program the cash register to accept one of the prices automatically according to certain rules.

The invention can be applied also to situations, where the electronic price label or corresponding price display is arranged into a scale or other weighing appliance to be used for weighing and pricing vegetables, fruits or other products. The scale may be a customer operated scale or a scale used by the shop staff. The latter type of scales are used, for example, at the fish or meat counters. In such a case the current price is typically printed on a adhesive price label to be attached to the product after weighing. In case that the price, for example EUR/kg, will be changed to a lower price during the time the customer walks to the cash register, the salesperson at the cash register may select the lower price for the benefit of the customer instead of the price printed on the adhesive price label. This requires of course that the mass of the product is readable on the adhesive price label in order to calculate the new price unless the sales person has a weighing machine or similar to be used with the cash register.

Instead of weight, the above mentioned applies also to any other appliance used in a store that measures one or more parameters of the product and use that/those to define the price for a customer selected volume or quantity of that bulk merchandise product or goods

Often price changes will be programmed hours or days before transmitting them to electronic label system. It is a common practice to send new price information from head office to stores during night time in connection with all other system updates. However, by means of the present invention, it is easy and reasonable to change prices even during shopping hours.

The implementation of the invention to the existing POS systems does not necessarily require any extra work because POS systems usually has either a double currency system or a special price feature already configured. These kinds of features already can show several price for a same product code. Such systems can be easily utilized when realizing the present invention. However, if such features cannot be found from the existing POS system, the only action to be performed is to program a new feature to the system by means of which the dual price feature can be obtained.

Further, if the price display at the cash register has limited capabilities and is capable of showing only one price at the time, it may be programmed to show the first and the second price in temporally successive manner, for example by showing each of the prices for a few seconds at the time in a blinking manner.

As has been described, the invention concerns a method for an electronic price system and the electronic price system. The invention also concerns an apparatus (that is a central computer) for the electronic price system, as well as a computer readable medium/computer program comprising instructions (i.e. code means) to perform, when run on a computer, the method as described above. The present invention has been described by means of examples. It is appreciated that the system of the invention can incorporate any number of other elements (e.g. databases, devices etc.) that can enhance system's functionality. The invention itself is specified in the following claims.

1. A method for an electronic price system comprising at least a cash register (27) and at least one electronic label (1, 2) for displaying a first price of a product, wherein a second price is transmitted to the electronic label (1, 2), said second price replacing the first price displayed in said electronic label, characterized in that the method further comprises
a. transmitting the second price to the cash register (27) to be displayed with the first price for a predetermined time period at the cash register (27), and
b. providing during said predetermined time period a possibility at the cash register (27) to accept the second price or the first price.

2. The method according to claim 1, characterized in that a price is accepted manually or automatically.

3. The method according to claim 1, characterized in that the method further comprises receiving a confirmation from the electronic label (1, 2) after the first price has been replaced with the second price.

4. The method according to claim 3, characterized in that the second price is transmitted to the cash register (27) after the confirmation has been received.

5. The method according to claim 1, characterized in that the second price is transmitted to said electronic label (1, 2) and to said cash register (27) substantially at the same time.

6. The method according to claim 1, characterized in that the second price being transmitted to the electronic label (1, 2) becomes a first price, wherein the method comprises transmitting a new second price to the electronic label (1, 2) and to repeat this step at predefined intervals.

7. The method according to claim 1, characterized by displaying at the cash register (27) also a time that has elapsed when the second price replaced the first price in the electronic label (1, 2).

8. The method according to claim 1, characterized in that the electronic label (1, 2) for displaying price is in connection with an appliance used to measure one or more parameters of the product in order to define the price for a customer selected volume or quantity of that bulk merchandise product or goods.

9. An electronic price system, comprising at least a cash register (27) and at least one electronic label (1, 2) for displaying a first price of a product, wherein said electronic price system is configured to transmit a second price to the electronic label (1, 2), said second price replacing the first price in said electronic label (1, 2), characterized in that,
a. the system is configured to transmit the second price to the cash register (27) to be displayed with the first price for a predetermined time period at the cash register (27), and
b. the system is configured to provide during said predetermined time period a possibility at the cash register (27) to accept the second price or the first price.

10. The system according to claim 9, characterized in that the acceptation of a price is manual or automatic.

11. The system according to claim 9, characterized in that the electronic label (1, 2) is configured to transmit a confirmation after the first price has been replaced with the second price.

12. The system according to claim 11, characterized in that the system is configured to transmit the second price to the cash register (27) after receiving the confirmation.

13. The system according to claim 9, characterized in that the system is configured to transmit the second price to said electronic label (1, 2) and to said cash register (27) substantially at the same time.

14. The system according to claim 9, characterized in that the second price being transmitted to the electronic label (1, 2) becomes a first price, wherein the system is configured to transmit a new second price to the electronic label (1, 2) and repeat this at predefined intervals.

15. The system according to claim 9, characterized in that the system is configured to display also at the cash register (27) a time that has elapsed when the second price replaced the first price in the electronic label (1, 2).

16. The system according to claim 9, characterized in that the electronic label (1, 2) for displaying price is in connection with an appliance used to measure one or more parameters of the product in order to define the price for a customer selected volume or quantity of that bulk merchandise product or goods.

17. A computer program for an electronic price system comprising at least a cash register (27) and at least one electronic label (1, 2) for displaying a first price of a product, said computer program comprising program code means configured, when the program is run on a computer, to transmit a second price to the electronic label (1, 2), said second price replacing the first price in said electronic label (1, 2), characterized in that the code means are further configured
a. to transmit the second price to the cash register (27) to be displayed with the first price for a predetermined time period at the cash register (27), and
b. to provide during said predetermined time period a possibility at the cash register (27) to accept the second price or the first price.

18. The method according to claim 2, characterized in that the method further comprises receiving a confirmation from the electronic label (1, 2) after the first price has been replaced with the second price.

19. The method according to claim 2, characterized in that the second price is transmitted to said electronic label (1, 2) and to said cash register (27) substantially at the same time.

20. The method according to claim 2, characterized in that the second price being transmitted to the electronic label (1, 2) becomes a first price, wherein the method comprises transmitting a new second price to the electronic label (1, 2) and to repeat this step at predefined intervals.
